(19) United States
(12) Patent Application Publication
(10) Pub. No.: US 2002/0147001 A1
(43) Pub. Date: Oct. 10, 2002

(54) Toll-free telephony systems

(76) Inventors: Mitchell J. Newdelman, Las Vegas, NV (US); Przemyslaw Jablonowski, Ernster (LU)

Correspondence Address: Thomas S. Baker, Jr., 1371 West 3rd Avenue, Columbus, OH, 43212, US

(21) Appl. No.: 09/826,985

(22) Filed: Apr. 5, 2001

(51) Int. Cl. H04M 11/00

(52) U.S. Cl. 455/405; 455/407; 455/406

(57) ABSTRACT

A method of processing toll-free calls in a wireless telephoning communication system by extracting and manipulating call data records.

### FIELD OF THE INVENTION

This invention relates to toll-free telephony systems. More particularly, this invention relates to a method of processing a call in a communication system utilizing Call Data Records (CDRs) to enable toll-free telephony. The invention is specifically directed to a wireless toll-free telephony system for wireless subscribers based on re-rating of Call Data Records.

### BACKGROUND OF THE INVENTION

Currently there are three types of toll-free services.

National toll-free systems using “0800” numbers, which re-recognized only at the national level, where callers must call from the country where the number has been allocated and dialing from foreign countries is not possible. Caller and owner of called number are always in the same country. This called numbers are the same for the whole country.

International toll-free systems, using national “0800” numbers and routing calls to a number, which can be in the same country or abroad. Caller and owner of called number can be in the same or other countries. Owner of the called number needs to purchase toll-free numbers in each country callers can all him from. All these called numbers are different, depending on countries.

Universal International Freephone Number (UIFN) where the country code is “0800” and this number can be called from different countries. Caller and owner of called number can be in the same or other countries. The called number is always the same in every country. A UIFN toll free telephone system is disclosed for exemple in U.S. Pat. No. 6,023,504.

Calls to all these numbers are free of charge for the caller; the company subscribing to the service subsequently pays for the charges. There is however, no control over the individual using a service, which could result in high charges borne by the owners of the numbers. There is indeed no possiblity of verifying the callers' identity.

All these systems are all based on special numbers issued by regulator agencies either nationally of by the International Telecommuncations Union (“ITU”) for UIFN, and are implemented on Intelligent Networks, where called numbers (specifically assigned new numbers beginning with the designation “0800”) need to be set-up in the databases of each of the operators from which the call will originate. The system then checks the number against the entry in the database and allows the call to start and terminate by routing it to the appropriate termination point. Billing system then generates the CDR in account of the owner of the called number.

The calls are only allowed if the called number has been recognized by the network originating calls.

What is needed is a toll-free system, which allows toll-free calling (i.e. toll free telphony) from wireless networks without the need of using any of the currently existing “toll-free systems”.

### SUMMARY OF THE INVENTION

In accordance with one aspect of the invention, there is provided a method of processing a call in a communication system utilizing Call Data Records (CDRs) generated by a Billing System of a wireless operator/provider to create a toll-free centralized system enabling toll-free telephony to certain numbers of selected subscribers of said operator/provider. The method comprises the steps of:

a) rating calls at “0” charge for the calls generated by the selected subscribers of the wireless operator/provider to predetermined client's numbers defined as toll-free numbers in the system,

b) extracting call records defined as A=IMSI, or subscriber's number, B=Client's number, and Charge=0, and ignoring or trashing all remaining CDRs,

c) rating off side CDRs associated with the call records at Charge=0 at the operator's side in the centralized system, and

d) re-rating the received off side CDRs and sending the received CDRs to the Clients for billing purposes, each client being owner of a number offered as a toll-free number to the selected wireless subscribers.

In accordance with another aspect of the invention, there is provided a method of processing a call in a communication system utilizing Call Date Records (CDRs) generated by a Billing System of a wireless operator/provider to create a toll-free centralized system enabling toll-free telephony to certain numbers of selected subscribers of said operator/provider, the method comprising the steps of:

a) receiving the extracted CDR's directly from the Billing System based on the criteria A=IMSI, or subscriber's number, and B=Client's number, and

b) re-rating the received CDRs and sending them to Clients for billing purposes, each client being owner of a number offered as a toll-free number to the selected wireless subscribers.

According to the invention, the method may create a toll-free centralized system enabling toll-free telephony to certain numbers of all subscribers of said operator/provider. The method comprising the steps of:

a) rating calls at “0” charge for the calls generated by all subscribers of the wireless operator/providers to predetermined clients' numbers defined as toll-free numbers in the system,

b) extracting call records defined as B=Client's number, and ignoring or trashing all remaining CDRs,

c) rating off side CDRs associated with the call records at Charge=0 at the operator's side in the centralized system, and

d) re-rating the received off side CDRs and sending the received CDRs to the Clients for billing purposes, each client being owner of a number offered as a toll-free number to all the wireless subscribers.

Alternatively, the method of the invention may create a toll-free centralized system enabling toll-free telephony to certain numbers of all subscribers of the operator/provider, the method comprising the steps of :

a) rating the extracted CDRs directly from the Billing System based on the criteria B=Client's number, and

b) re-rating the extracted CDRs and sending them to Clients for billing purposes, each client being owner of a number offered as a toll-free number to all the wireless subscribers.

It is a principal object of the invention to provide an improved method of processing a call utilizing Call Date Records (CDRs) to create a toll-free centralized system enabling toll-free telephony to certain numbers of certain subscribers of the operator/provider.

It is another object of the invention to create a toll-free system, which allows toll-free calling (i.e. toll free telephony) from wireless networks without the need of using any of the currently existing “toll-free systems”.

The process of the invention uses Call Data Records (CDRs) in order to receive, manipulate and re-rate them and subsequently change the flow of billing to invoice not the caller, but the called party.

The invention covers the process where called party can use existing numbers and offers their clients toll-free calls to these numbers using wireless networks.

Callers (end-users of the system) are subscribers of the existing providers (and/or wireless operators) and they are not required to change providers (and/or wireless operator) or the type of their subscription in order to call toll-free.

The system can be used for national toll-free calls only (caller in the same country as called party), international toll-free calls (caller in his home country, called party in another county), and roaming calls (caller in other country, called party either in caller's home country or in another country).

The system is the first truly internationally working toll-free system.

The system can be used both for voice and data toll-free calls.

The method and system of the invention operates based on the following principles:

1. The numbers used to offer described services are not regulated in any jurisdiction as “special numbers” or toll-free numbers. These numbers are simply any telephone number that can be accessed without any restrictions and/or special pricing scheme from any telecom provider in the country of issue and from abroad.

2. The system may be fully used by subscribers (those callers specifically invited to use the number by the Called Party) of those wireless networks that have agreed to co-operate with the system while the actual numbers may still accessible by all the others (callers not invited to use it by the called party), but without the benefits of the system.

3. The system may be fully used by subscribers (those callers generally invited to use the number by the Called Party such as through a broadly published number) of those wireless networks that have agreed to co-operate with the system in which case all callers to that number will have the benefits of the system.

The system enables financial reconcilation between wireless operators/providers and persons/companies (respective called parties) offering the service to their respective clients, customers or prospective clients or customers. This is done by extracting Call Data Records (CDRs) from operators/providers, manipulating them, re-rating them and sending pertinent information derived from those CDR's to the Called persons or companies in order to respectively invoice those Called Parties for the calls they received. This creates a “billing” toll-free system where subscribers of wireles operators/providers are not charged for calls to persons/companies offering the service, and these persons/companies pay the owner or operator of the system or system clearinghouse that in turn pays to all participating wireless operators/providers their due charges.

Further objects, features and advantages of the invention will be apparent from the following detailed description when taken in conjunction with the accompanying drawings.

### BRIEF DESCRIPTION OF THE DRAWINGS

In the accompanying drawings:

FIG. 1 is a schematic representation of the whole system according to a first embodiment of the invention, where data comprises records extracted and treated (manipulated by software) based on subscriber identification and called number identification; and

FIG. 2 is a schematic representation of the whole system according to second embodiment of the invention, where data comprises records extracted and treated (manipulated by software) based on called number identification only.

### DESCRIPTION OF THE PREFERRED EMBODIMENTS

The entire integrated seamless set of subsystems consists of three main components allocated at client (“called party”) site, central site (“system site”) and wireless operator/provider site.

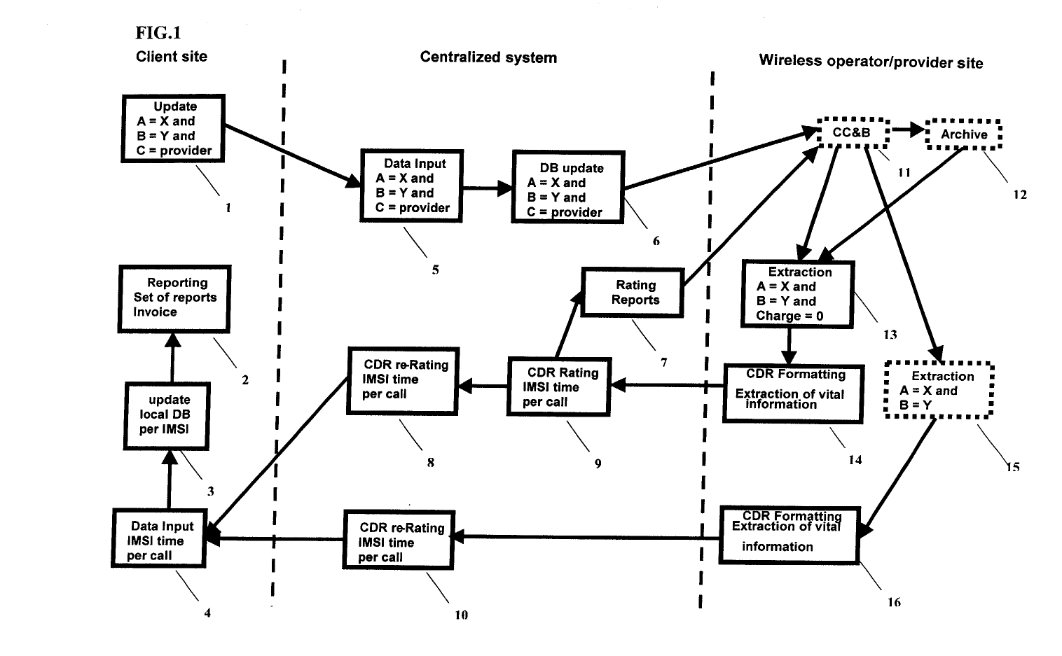

FIG. 1 shows the system used for extraction and treatment of CDRs based on subscriber identification and called number identification. Here Clients input information with IMSI (International Mobile Subscriber Identity) or subscriber's number being the person whom the access to toll-free number is granted. This is inputted into a user interface 1 and the required information are A=IMSI, or subscriber's number, B=Clients' number, and C=wireless operator/provider of the subscriber.

This information is submitted over to the centralized system and namely to the centralized database 5, which will do necessary updates to assign inputted IMSI, or subscriber's number to a specific wireless operator/provider 6. From here this information is submitted to corresponding wireless operator/provider and stored in 11 Customer Care and Billing System (CC&B) From here there are two possibilities of Call Data Records extraction.

Possibility number one is that based on these parameters Billing system 11 inputs “charge of all calls from the subscriber X to number Y” equals 0 which means that these calls will be rated “0”, then a copy of all call records will be sent from the billing system 11 to extracting module 13 either directly from the CC&B 11 or from the archive 12.

The extraction module separates “toll-free” CDRs (Call Data Records) from “others” and ignores or trashes all “others” CDRs, this process is based on criteria A number=IMSI or subscribers' number, B number=Client's number, charge=0. The CDR formatting device 14 reads, translates and reformates the records into a proprietary format to send them to the centralized system, namely to CDR rating module 9

The CDR rating module 9 then rates calls according to agreements with operators and rating reports module 7 sends rating reports to wireless operator/provider. Call records are sorted by the CDR rating module 9 according to Clients and the CDRs passes through the re-rating module 8 and a file with re-rated call records is sent to the data input module 4, and records are input into the local database 3, which provides clients with reports via reports module 2.

Possibility number two is that based on these parameters Billing system 11 performs direct extraction of CDRs based on inputted criteria in extraction module 15 and sends them to the CDR formatting device 17, which reads, translates and reformates the records into a proprietary format to send them to the centralized system, namely to CDR re-rating module 10. The file with re-rated call records is sent to the data input module 4 and records are input into the local database 3, which provides client with reports via reports module 2.

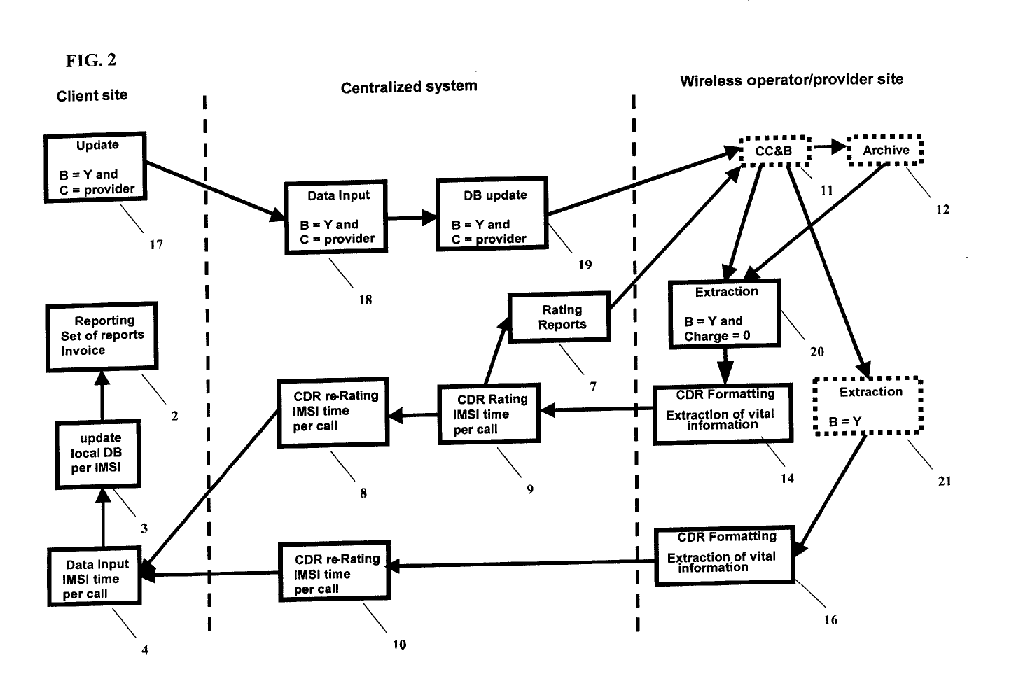

FIG. 2 shows the system used for extraction and treatment of CDRs based on called number identification only. Here Clients input information with their number and provider they want to work with. This is inputted into a user interface 17 and the required information are, B=Clients' number, and C=wireless operator/provider of the subscriber.

This information is submitted over to the centralized system and namely to the centralized database 18, which does necessary updates to assign inputted number to a specific wireless operator/provider 19. From here this information is submitted to corresponding wireless operator/provider and stored in 11, Customer Care and Billing System (CC&B). From here there are two possibilities of Call Data Records extraction.

Possibility number one is that based on these parameters Billing system 11 inputs “charge of all calls to number Y” equals 0 which means that these calls are rated “0”, then a copy of all call records are sent from the billing system 11 to extracting module 20 either directly from the CC&B 11 or from the archive 12.

The extraction module separates “toll-free” CDRs (Call Data Records) from “others” and ignores or trashes all “others” CDRs, this process is based on criteria, B number=Client's number, charge =0. The CDR formatting device 14 reads, translates and reformates the records into a proprietary format to send them to the centralized system, namely to CDR rating module 9 The CDR rating module 9 then rates calls according to agreements with operators and rating reports module 7 sends rating reports to wireless operator/provider. Call records are sorted by the CDR rating module 9 according to Clients and the CDRs passes through the re-rating module 8 and a file with re-rated call records are sent to the data input module 4, and records are input into the local database 3, which provides clients with reports via reports module 2.

Possibility number two is that based on these parameters Billing system 11 performs direct extraction of CDRs based on inputted criteria in extraction module 21 and sends them to the CDR formatting device 17, which reads, translates (or manipulate by software) and reformates the records into a proprietary format to send them to the centralized system, namely to CDR re-rating module 10. The file with re-rated call records is sent to the data input module 4, and records are input into the local database 3, which provides clients with reports via reports module 2.

It is understood that the invention is not limited to the particular processes and arrangements of parts herein illustrated and described, but embraces such modified forms thereof as come within the scope of the following claims.

What is claimed is:

1. A method of processing a call in a communication system utilizing Call Data Records (CDRs) generated by a Billing System of a wireless operator/provider to create a toll-free centralized system enabling toll-free telephony to certain numbers of selected subscribers of said operator/provider, said method comprising the steps of:
a) rating calls at “O” charge for the calls generated by the selected subscribers of the wireless operator/provider to predetermined client's numbers defined as toll-free numbers in the system,
b) extracting call records defined as A=IMSI, or subscriber's number, B=Client's number, and Charge=0, and ignoring or trashing all remaining CDRs,
c) rating off side CDRs associated with the call records at Charge=0 at the operator's side in the centralized system, and
d) re-rating the received off side CDRs and sending the received CDRs to the Clients for billing purposes, each client being owner of a number offered as a toll-free number to the selected wireless subscribers.

2. A method of processing a call in a communication system utilizing Call Date Records (CDRs) generated by a Billing System of a wireless operator/provider to create a toll-free centralized system enabling toll-free telephony to certain numbers of selected subscribers of said operator/provider, said method comprising the steps of:
a) receiving the extracted CDR's directly from the Billing System based on the criteria A=IMSI, or subscriber's number, and B=Client's number, and
b) re-rating the received CDRs and sending them to Clients for billing purposes, each client being owner of a number offered as a toll-free number to the selected wireless subscribers.

3. A method of processing a call in a communication system utilizing Call Data Records (CDRs) generated by a Billing System of a wireless operator/provider to create a toll-free centralized system enabling toll-free telephony to certain numbers of all subscribers of said operator/provider, said method comprising the steps of:
a) rating calls at “O” charge for the calls generated by all subscribers of the wireless operator/provider to predetermined clients' numbers defined as toll-free numbers in the system,
b) extracting call records defined as B=Client's number, and Charge=0, and ignoring or trashing all remaining CDRs,
c) rating off side CDRs associated with the call records at Charge=0 at the operator's side in the centralized system, and
d) re-rating the received off side CDRs and sending the received CDRs to the Clients for billing purposes, each client being owner of a number offered as a toll-free number to all the wireless subscribers.

4. A method of processing a call in a communication system utilizing Call Date Records (CDRs) generated by a Billing System of a wireless operator/provider to create a toll-free centralized system enabling toll-free telephony to certain numbers of all subscribers of said operator/provider, said method comprising the steps of.
a) rating the extracted CDRs directly from the Billing System based on the criteria B=Client's number, and
b) re-rating the extracted CDRs and sending them to Clients for billing purposes, each client being owner of a number offered as a toll-free number to all the wireless subscribers.
